(19) United States
(12) Patent Application Publication
(10) Pub. No.: US 2020/0284511 A1
(43) Pub. Date: Sep. 10, 2020

(54) OVEN AND DISPLAY PANEL MANUFACTURING APPARATUS

(71) Applicant: HKC CORPORATION LIMITED, Shenzhen (CN)

(72) Inventor: LEI ZHANG, Chongqing (CN)

(21) Appl. No.: 16/349,970

(22) PCT Filed: Dec. 6, 2018
(86) PCT No.: PCT/CN2018/119552

§ 371 Date: May 14, 2019

(30) Foreign Application Priority Data
Nov. 26, 2018 (CN) 201821960016.7

(51) Int. Cl. F26B 21/02; B41F 23/04; F26B 9/08; F26B 3/04; F26B 25/08

(52) U.S. Cl. CPC F26B 21/02; B41F 23/04; F26B 25/08; F26B 3/04; F26B 9/08

(57) ABSTRACT

An oven and a display panel manufacturing apparatus are disclosed. The oven includes: an accommodation device; a suction device configured to deliver gas into the oven; a gas inlet passage configured to convey hot gas into the accommodation device; a gas return passage configured to return the hot gas sent out from the accommodation device back to the gas inlet passage; and a first filtering device located inside the gas return passage.

The present application claims priority to Chinese Patent Application No. CN201821960016.7, filed to the National Intellectual Property Administration, PRC on Nov. 26, 2018, and entitled “OVEN AND DISPLAY PANEL MANUFACTURING APPARATUS”, which is incorporated herein by reference in its entirety.

### TECHNICAL FIELD

The present application relates to the field of display technologies, and in particular, to an oven and a display panel manufacturing apparatus.

### BACKGROUND

The description herein merely provides background information related to the present application and does not necessarily constitute the prior art.

With the development and advancement of science and technology, a flat panel display has become a mainstream product of displays due to its thin body, power saving, and low radiation, and is widely applied. The flat panel display includes a thin film transistor-liquid crystal display (TFT-LCD), an organic light-emitting diode (OLED) display, and the like. The thin film transistor-liquid crystal display controls the rotation directions of liquid crystal molecules to refract light of a backlight module to produce a picture, and has many advantages of a thin body, power saving, no radiation, and on the like. The organic light emitting diode display is made of an organic electroluminescent diode, and has many advantages of being self-luminous, a short response time, high definition and contrast, flexible display, large-area fill-color display, and the like.

In a manufacturing process of each substrate of the flat panel display, generally, after development, the substrate needs to be heated in an oven, organic sublimates accumulate in the oven, the sublimates fall onto the substrate to cause defects, and most defects have large areas and cannot be repaired.

### SUMMARY

An object of the present application is to provide an oven and a display panel manufacturing apparatus, to reduce accumulation of sublimates.

To achieve the foregoing object, the present application provides an oven. The oven includes: an accommodation device located inside the oven and configured to accommodate a color film substrate; a suction device configured to deliver gas into the oven; a gas inlet passage configured to convey hot gas into the accommodation device; a gas return passage configured to return the hot gas sent out from the accommodation device back to the gas inlet passage;

and a first filtering device located inside the gas return passage.

Optionally, the suction device includes a gas inlet, the gas inlet is located at a boundary between the gas inlet passage and the gas return passage, the gas inlet passage includes a heating device, a gas supply device and a second filtering device in sequence along a gas flow direction, the heating device is adjacent to the gas inlet, the gas supply device is adjacent to the heating device, and the second filtering device is disposed at a gas inlet position of the accommodation device.

Optionally, the accommodation device includes first support frames and partition plates, the first support frames are stacked, accommodation space configured to accommodate the color film substrate is formed between two adjacent first support frames, and the partition plates are disposed on the first support frame.

Optionally, a material of the partition plates is metal.

Optionally, the oven includes a door plate, an exhaust passage, and an exhaust hole, the exhaust passage is located outside the gas return passage, the door plate is located outside an inner exhaust duct, and the exhaust hole is disposed on a side wall of the exhaust passage to discharge gas in the gas return passage out of the oven.

Optionally, the exhaust hole is circular in shape.

Optionally, the first filtering device includes a filter element and second support frames, there are two second support frames, the second support frames are disposed in parallel, the filter element is disposed between the two second support frames, and the filter element is made of a polypropylene material.

Optionally, the filter element includes at least two layers of filter screens, and the filter screens are stacked.

The present application further discloses an oven. The oven includes: an accommodation device located inside the oven and configured to accommodate a color film substrate; a suction device configured to deliver gas into the oven; a gas inlet passage configured to convey hot gas into the accommodation device; a gas return passage, configured to return the hot gas sent out from the accommodation back to the gas inlet passage; a first filtering device located inside the gas return passage; an exhaust passage located outside located outside the gas return passage; a door plate located outside the exhaust passage; and an exhaust hole disposed on a side wall of an exhaust passage to discharge gas in the gas return passage out of the oven.

The accommodation device includes first support frames and partition plates, and the first support frames are stacked, and accommodation space used to accommodate the color film substrate is formed between two adjacent layers of the first support frames; the partition plates are arranged on the first support frames; the first filtering device includes a filter element and second support frames, there are two second support frames, the second support frames are disposed in parallel, and the filter element is disposed between the two second support frames, and the filter element is made of a polypropylene material; and the filter element includes at least two layers of filter screens, and the filter screens are stacked.

The present application further discloses a display panel manufacturing apparatus, including an oven. The oven includes: an accommodation device located inside the oven and configured to accommodate a color film substrate; a suction device configured to deliver gas into the oven; a gas inlet passage configured to convey hot gas into the accommodation device; a gas return passage, return the hot gas sent out from the accommodation device back to the gas inlet passage; and a first filtering device located inside the gas return passage.

Optionally, the suction device includes a gas inlet, the gas inlet is located at a boundary between the gas inlet passage and the gas return passage, the gas inlet passage includes a heating device, a gas supply device, and a second filtering device in sequence along a gas flow direction, the heating device is adjacent to the gas inlet, the gas supply device is adjacent to the heating device, the second filtering device is disposed at a gas inlet position of the accommodation device.

Optionally, the accommodation device includes first support frames and partition plates, the first support frames are stacked, accommodation space used to accommodate the color film substrate is formed between two adjacent layers of the first support frames, and the partition plates are disposed on the first support frames.

Optionally, a material of the partition plates is metal.

Optionally, the oven includes a door plate, an exhaust passage, and an exhaust hole, the exhaust passage is located outside the gas return passage, the door plate is located outside an inner exhaust duct, and the exhaust hole is disposed on a side wall of the exhaust passage to discharge gas in the gas return passage out of the oven.

Optionally, the exhaust hole is circular in shape.

Optionally, the first filtering device includes a filter element and second support frames, there are two second support frames, the second support frames are disposed in parallel, the filter element is disposed between the two second support frames, and the filter element is made of a polypropylene material.

Optionally, the filter element includes at least two layers of filter screens, and the filter screens are stacked.

Optionally, the first filtering device includes a filter element and second support frames, there are two second support frames, the second support frames are disposed in parallel, the filter element is disposed between the two second support frames, and the filter element is made of a polysulfone ultrafiltration membrane material.

Compared with a solution in which there is no filtering device in the gas return passage, in the present application, sublimates are generated and accumulate after the substrate is baked through high-temperature gas, the sublimates arrive at the gas return passage along with circulating gas, the first filtering device in the gas return passage adsorbs the sublimates and prevents the sublimates from re-entering the gas inlet passage along with circulating gas, thereby avoiding circulation of sublimates and protecting the substrate. More sublimates are generated during a baking process due to a color resistance on the color film substrate, and therefore, the present application is especially suitable for a manufacturing process of the color film substrate.

### BRIEF DESCRIPTION OF DRAWINGS

The drawings are included to provide further understanding of embodiments of the present application, which constitute a part of the specification and illustrate the embodiments of the present application, and describe the principles of the present application together with the text description. Apparently, the accompanying drawings in the following description show merely some embodiments of the present application, and a person of ordinary skill in the art may still derive other accompanying drawings from these accompanying drawings without creative efforts. In the accompanying drawings:

FIG. 1 is a schematic diagram of a yellow light manufacturing process of a color film substrate;

FIG. 2 is a schematic diagram of an oven according to an embodiment of the present application;

FIG. 3 is a schematic diagram of an oven provided with an exhaust hole, a partition plate, and a filtering device according to an embodiment of the present application;

FIG. 4 is a schematic diagram of an exhaust hole according to an embodiment of the present application;

FIG. 5 is a schematic diagram of the inside and outside of a side wall of an exhaust passage according to an embodiment of the present application;

FIG. 6 is a schematic diagram of an open door plate according to an embodiment of the present application;

FIG. 7 is a schematic diagram of a closed door plate according to an embodiment of the present application;

FIG. 8 is a schematic diagram of a filtering device according to an embodiment of the present application; and

FIG. 9 is a schematic diagram of a display panel manufacturing apparatus according to an embodiment of the present application.

### DETAILED DESCRIPTION

The specific structure and function details disclosed herein are merely representative, and are intended to describe exemplary embodiments of the present application. However, the present application can be specifically embodied in many alternative forms, and should not be interpreted to be limited to the embodiments described herein.

In the description of the present application, it should be understood that, orientation or position relationships indicated by the terms “center”, “transversal”, “upper”, “lower”, “left”, “right”, “vertical”, “horizontal”, “top”, “bottom”, “inner”, “outer”, etc. are based on the orientation or position relationships as shown in the drawings, for ease of the description of the present application and simplifying the description only, rather than indicating or implying that the indicated device or element must have a particular orientation or be constructed and operated in a particular orientation. Therefore, these terms should not be understood as a limitation to the present application. In addition, the terms such as “first” and “second” are merely for a descriptive purpose, and cannot be understood as indicating or implying a relative importance, or implicitly indicating the number of the indicated technical features. Hence, the features defined by “first” and “second” can explicitly or implicitly include one or more features. In the description of the present application, “a plurality of” device two or more, unless otherwise stated. In addition, the term “include” and any variations thereof are intended to cover a non-exclusive inclusion.

In the description of the present application, it should be understood that, unless otherwise specified and defined, the terms “install”, “connected with”, “connected to” should be comprehended in a broad sense. For example, these terms may be comprehended as being fixedly connected, detachably connected or integrally connected; mechanically or electrically connected; or directly connected or indirectly connected through an intermediate medium, or in an internal communication between two elements. The specific meanings about the foregoing terms in the present application may be understood by those skilled in the art according to specific circumstances.

The terms used herein are merely for the purpose of describing the specific embodiments, and are not intended to limit the exemplary embodiments. As used herein, the singular forms “a”, “an” are intended to include the plural forms as well, unless otherwise indicated in the context clearly. It will be further understood that the terms “include” and/or “include” used herein specify the presence of the stated features, integers, steps, operations, elements and/or components, but do not preclude the presence or addition of one or more other features, integers, steps, operations, elements, components and/or combinations thereof.

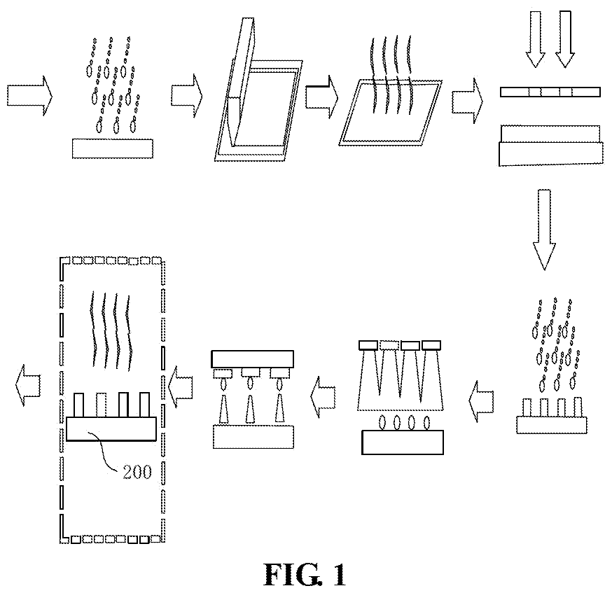

Taking a yellow light manufacturing process of a color film substrate as an example, the yellow light manufacturing process includes eight steps: glass substrate cleaning, photoresist coating, color film pre-baking, exposure, development, infrared baking, automatic optical detection, and color film baking. Referring to the last step in FIG. 1, each color film substrate needs to be heated by an oven 200, to dry and cure the photoresist on the color film substrate. However, because the photoresist itself contains a solvent and the like, when baked, organic sublimates accumulate in the oven 200 after a long time, when the sublimates are condensed to some extent, the sublimates falls onto the color film substrate to cause defects, and most defects have large areas and cannot be repaired.

The present application is optionally described below with reference to the accompanying drawings and optional embodiments.

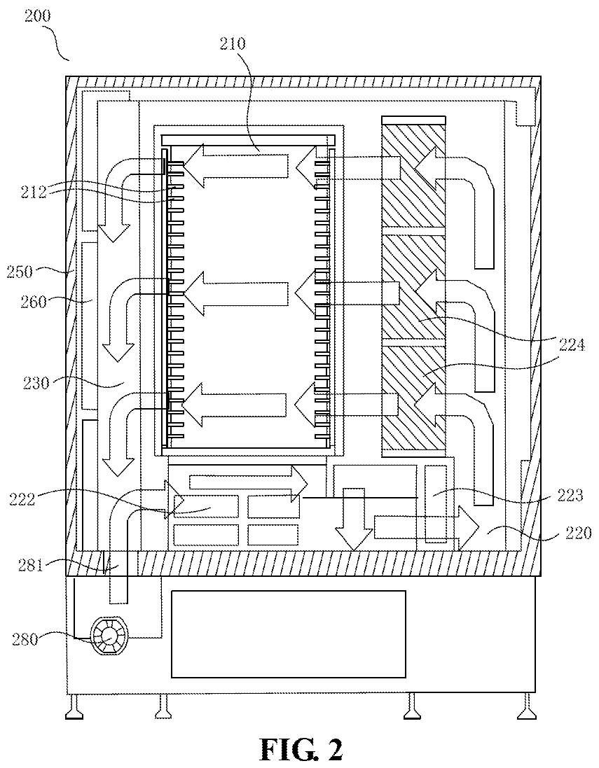

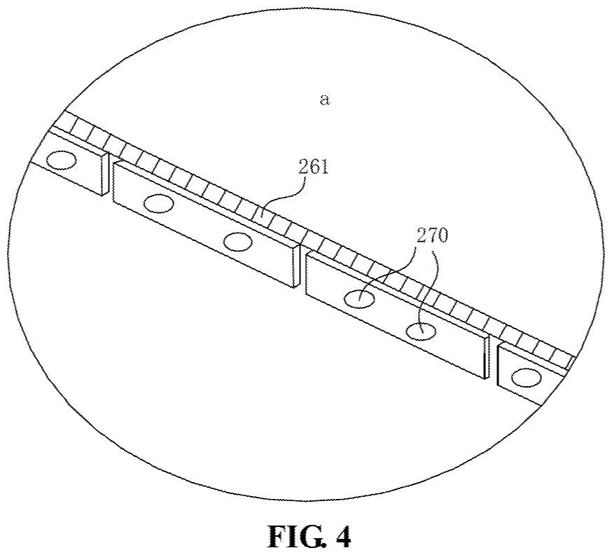

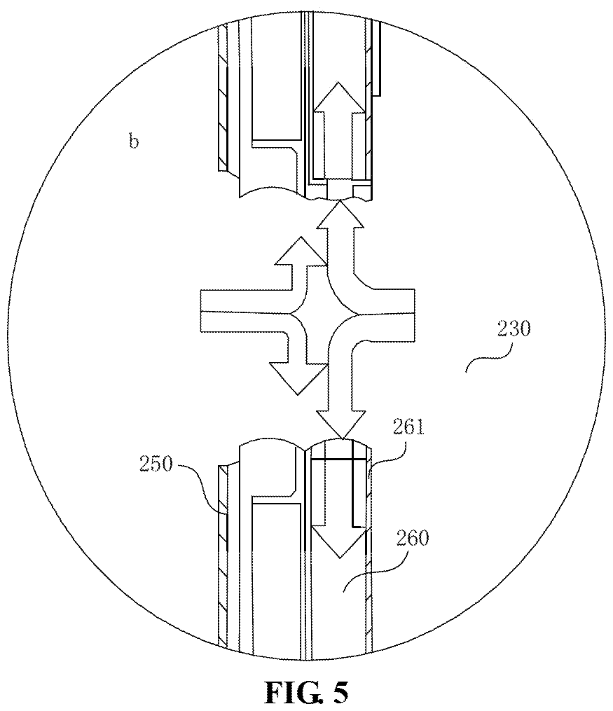

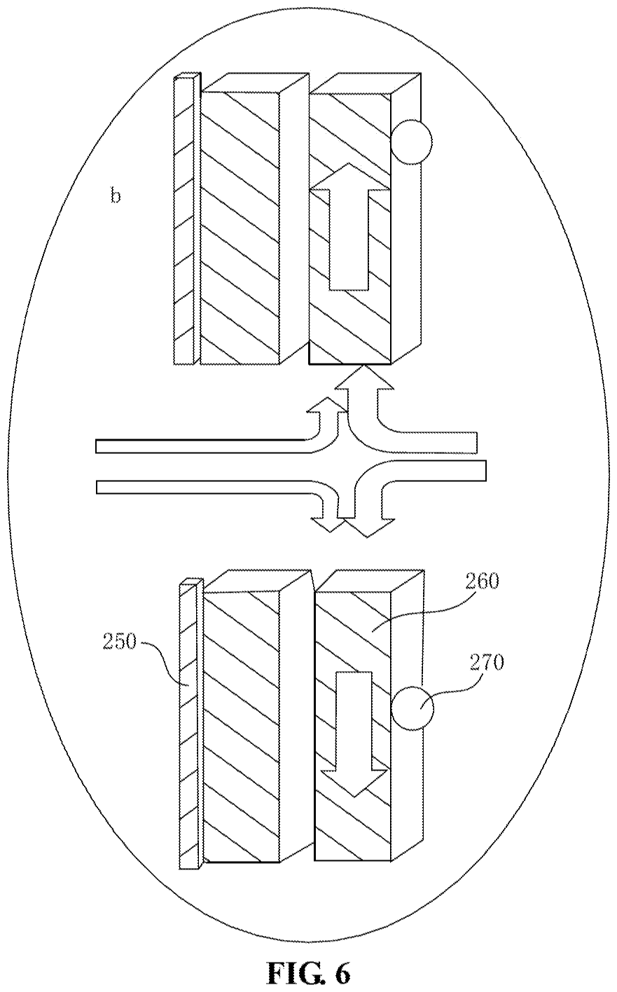

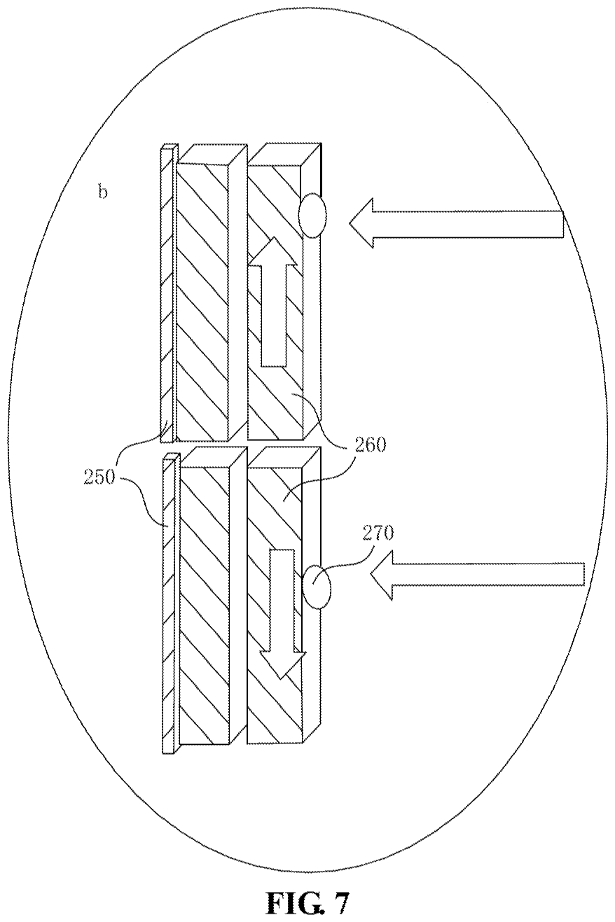

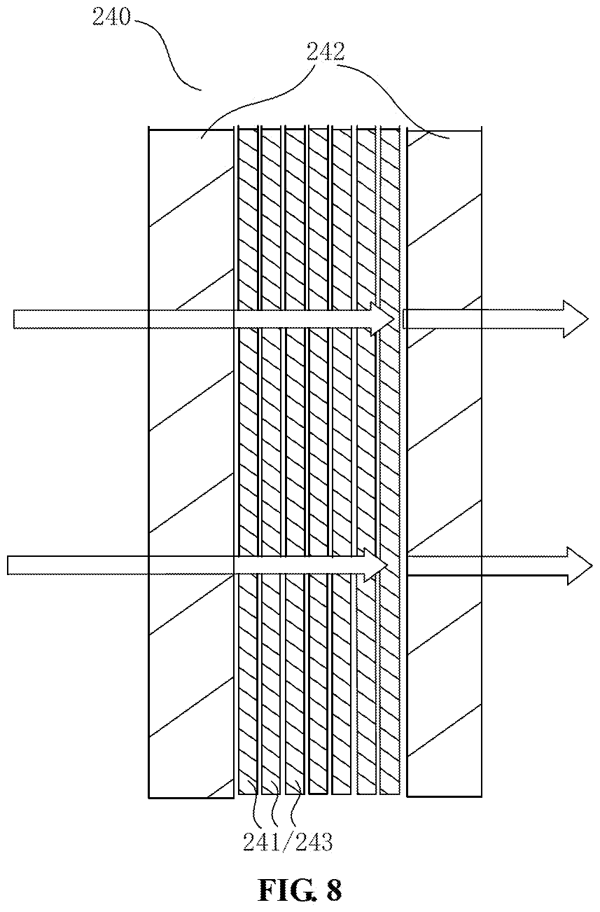

As shown in FIG. 2 to FIG. 8, an embodiment of the present application discloses an oven 200. The oven 200 includes: an accommodation device 210 located inside the oven 200 and configured to accommodate a color film substrate; a suction device 280 configured to deliver gas into the oven 200; a gas inlet passage 220 configured to convey hot gas into the accommodation device 210; a gas return passage 230, configured to return the hot gas sent out from the accommodation device 210 back to the gas inlet passage 220; and a first filtering device 240 located inside the gas return passage 230.

Compared with a solution in which there is no filtering device in a gas return passage, in this solution of the present application, sublimates are generated and accumulate after the substrate is baked through high-temperature gas, the sublimates arrive at the gas return passage along with circulating gas, the first filtering device in the gas return passage adsorbs the sublimates and prevents the sublimates from re-entering the gas inlet passage along with circulating gas, thereby avoiding circulation of sublimates and protecting the substrate. More sublimates are generated during a baking process due to a color resistance on the color film substrate, and therefore, the solution is especially suitable for a manufacturing process of the color film substrate.

In an embodiment, the suction device 280 includes a gas inlet, the gas inlet is located at a boundary between the gas inlet passage 220 and the gas return passage 230, the gas inlet passage 220 includes a heating device 222, a gas supply device 223, and a second filtering device 221 in sequence along a gas flow direction, the heating device 222 is adjacent to the gas inlet, the gas supply device 223 is adjacent to the heating device 222, and the second filtering device 221 is disposed at a gas inlet position of the accommodation device 210.

In this solution, the suction device 280 conveys gas from the gas inlet to the gas inlet passage 220, the heating device 222 heats the gas, the gas supply device 223 supplies power to the heated gas, and conveys the heated gas to the second filtering device 221. Generally, gas entering from the gas inlet is air, and contains some impurities, and the second filtering device 221 may filter the impurities in the gas entering from the gas inlet, so that the impurities do not affect the color film substrate in the accommodation device 210.

In an embodiment, the accommodation device 210 includes first support frames 212 and partition plates 211, the first support frames 212 are stacked, accommodation space used to accommodate the color film substrate is formed between two adjacent first support frames 212, and the partition plates 211 are disposed on the first support frames 212.

In this solution, because the color film substrate is stacked on the first support frame 212, the accommodation device 210 is relatively high, and circulating gas does not pass through the accommodation device 210 horizontally, but at a particular angle, a circulating gas flow is unstable, and generated sublimates always remain in the accommodation device 210 and cannot be filtered out. The partition plates 211 are disposed on the first support frames 212, so that a height of each layer in the accommodation device 210 is indirectly reduced, and the number of placed color film substrates is not affected. In this way, circulating gas passes relatively in parallel, and the circulating gas flow is more stable, so that the sublimates are easily removed. When the color film substrate is broken, the partition plates 211 may further stop fragments from falling, thereby protecting the color film substrate below the partition plates 211, and reducing an impact caused by the fragments.

In an embodiment, a material of the partition plates 211 is metal.

In this solution, the metal has a good heat conduction property, and maintains a temperature close to an ambient temperature of the metal, so that a temperature of the accommodation device 210 is more uniform, and the color film substrate is sufficiently baked. In addition, the metal has relatively good strength and thermal stability, so that strength of the partition plates 211 is ensured when the color film substrate is broken, and the partition plates 211 can further maintain stable at a temperature of 100° C.

In an embodiment, there are more than one partition plates 211.

In this solution, the accommodation device 210 may be divided into more regions, a height of each region is lower than a previous height, so that circulating gas passes through the accommodation device 210 as horizontally as possible, and the circulating gas flow is more stable, facilitating removal of the sublimates. When a color film substrate is broken, more color film substrates are protected, and an impact caused by the fragments is reduced.

In an embodiment, the oven 200 includes a door plate 250, an exhaust passage 260, and an exhaust hole 270, the exhaust passage 260 is located outside the gas return passage 230, the door plate 250 is located outside an inner exhaust duct, and the exhaust hole 270 is disposed on a side wall 261 of the exhaust passage to discharge gas in the gas return passage 230 out of the oven 200.

In this solution, the door plate 250 is configured to seal the oven 200 after the color film substrate is taken out or placed, and the exhaust hole 270 is disposed on the side wall of the exhaust passage 260, so that a part of the sublimates is taken away due to a negative pressure when the door plate 250 is closed, thereby reducing the content of the residual sublimates in the oven 200 and a load on the filtering device.

In an embodiment, the exhaust hole 270 is circular in shape.

In this solution, because the sublimates may remain in the exhaust hole 270 after a long time of use, and the filtering efficiency may be affected if the exhaust hole is not cleaned, regular cleaning is needed. Only a dust-free cloth and alcohol are needed during cleaning, and it is convenient and simple. The circular exhaust hole 270 has no corners, facilitating wiping of the dust-free cloth.

In an embodiment, the first filtering device 240 includes a filter element 241 and second support frames 242, there are two second support frames 242, the second support frames 242 are disposed in parallel, the filter element 241 is disposed between the two second support frames 242, and the filter element 241 is made of a polypropylene material.

In this solution, the two second support flames 242 fix the filter element 241 in the gas return passage 230 to prevent the filter element 241 from shaking. The filter element 241 is made of the polypropylene material, the sublimates generated after baking are organic, and the polypropylene easily adsorbs the sublimates. In addition, the polypropylene has relatively good corrosion resistance and heat resistance, and a melting point thereof is as high as 167° C. Because an internal temperature of the oven 200 is below 100° C., the polypropylene maintains a good physical property thereof during baking, and a filtering effect thereof is not affected.

In an embodiment, the filter element 241 includes at least two layers of filter screens 243, and the filter screens 243 are stacked.

In this solution, the filter element 241 consists of the filter screens 243. To improve a filtering effect of the filter element 241, the filter screens 243 are stacked into a plurality of layers, so that a distance at which the sublimates pass through the filter screen 243 is increased and the filtering effect of the filter element 241 is improved.

In an embodiment, the first filtering device 240 includes a filter element 241 and second support frames 242, there are two second support frames 242, the second support frames 242 are disposed in parallel, the filter element 241 is disposed between the two second support frames 242, and the filter element 241 is made of a polysulfone ultrafiltration membrane material.

In this solution, the two second support flames 242 fix the filter element 241 in the gas return passage 230 to prevent the filter element 241 from shaking. The filter element 241 is made of the polysulfone ultrafiltration membrane material, and a polysulfone ultrafiltration membrane is an engineering plastic film formed by condensation of an organic substance, and can separate particles, fly ash, and an aerosol in a liquid phase or a gas phase. Because a photoresist itself contains a solvent, the solvent is sublimed to form organic impurities after the color film substrate is baked, and the organic substance easily adsorbs the organic substance, an adsorption effect of the polysulfone ultrafiltration membrane is greatly improved. Because a baking temperature is 100° C., and a temperature of the solvent that is sublimated to form the organic impurities after baking is also close to 100° C., the chemical stability and thermal stability of the filtering device 240 are both good. In addition, a glass transition temperature (Tg) of the polysulfone ultrafiltration membrane is relatively high and is 190° C., the polysulfone ultrafiltration membrane maintains a good physical property during baking, and a filtering effect thereof is not affected.

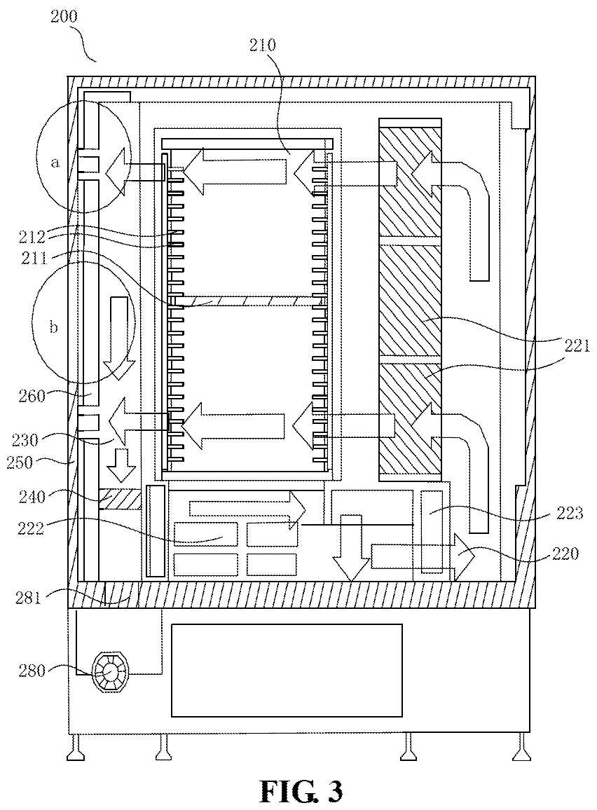

As shown in FIG. 3 to FIG. 8, another embodiment of the present application discloses an oven 200. The oven 200 includes: an accommodation device 210 located inside the oven 200 and configured to accommodate a color film substrate; a suction device 280 configured to deliver gas into the oven 200; a gas inlet passage 280 configured to convey hot gas into the accommodation device 210, a gas return passage 230 configured to return, to the gas inlet passage 220, the hot gas sent out from the accommodation device 210, and a first filtering device 240 located inside the gas return passage 230.

The accommodation device 210 includes first support frames 212 and partition plates 211, the first support frames 212 are stacked, and accommodation space used to accommodate the color film substrate is formed between two adjacent first support frames 212; the partition plates 211 are disposed at the first support frames 212; and a material of the partition plates 211 is metal. The oven 200 includes a door plate 250, an exhaust passage 260, and an exhaust hole 270. The exhaust passage 260 is located outside the gas return passage 230, the door plate 250 is located outside an inner exhaust duct, and the exhaust hole 270 is disposed on a side wall 261 of the exhaust passage to discharge gas in the gas return passage 230 out of the oven 200. The exhaust hole 270 is circular in shape. The first filtering device 240 includes a filter element 241 and second support frames 242. There are two second support frames 242, the second support frames 242 are disposed in parallel, and the filter element 241 is disposed between two the second support frames 242. The filter element 241 is made of a polypropylene material. The filter element 241 includes at least two layers of filter screens 243, and the filter screens 243 are stacked.

Sublimates are generated and accumulate after a photoresist on the color film substrate is baked through high-temperature gas, the sublimates arrive at the gas return passage 230 along with circulating gas, and the filtering device in the gas return passage 230 adsorbs the sublimates and prevents the sublimates from re-entering the gas inlet passage 220 along with circulating gas, thereby avoiding circulation of the sublimates and protect the color film substrate. Because the color film substrates are stacked on the first support frames 212, the accommodation device 210 is relatively high, and the circulating gas cannot pass through the accommodation device 210 horizontally, but at a particular angle, a circulating gas flow is not stable, and the generated sublimates always remain in the accommodation device 210 and cannot be filtered out. The partition plates 211 are disposed on the first support frames 212, so that a height of each layer in the accommodation device 210 is indirectly reduced, and the number of placed color film substrates is not affected. In this case, the circulating gas passes relatively in parallel, and the circulating gas flow is more stable, so that the sublimates are easily removed. When the color film substrate is broken, the partition plates 211 may further stop fragments from falling, thereby protecting the color film substrate below the partition plates 211, and reducing an impact caused by the fragments. The metal has a good heat conduction property, and maintains a temperature close to an ambient temperature of the metal, so that a temperature of the accommodation device 210 is more uniform, and the color film substrate is sufficiently baked. In addition, the metal has relatively good strength and thermal stability, so that strength of the partition plates 211 is ensured when the color film substrate is broken, and the partition plates 211 can further maintain stable at a temperature of 100° C.

The door plate 250 is configured to seal the oven 200 after the color film substrate is taken out or placed, and the exhaust hole 270 is disposed on the side wall of the exhaust passage 260, so that a part of the sublimates is taken away due to a negative pressure when the door plate 250 is closed, thereby reducing the content of the residual sublimates in the oven 200 and a load on the filtering device. Because the sublimates may remain in the exhaust hole 270 after a long time of use, and the filtering efficiency may be affected if the exhaust hole is not cleaned, regular cleaning is needed. Only a dust-free cloth and alcohol are needed during cleaning, and it is convenient and simple. The circular exhaust hole 270 has no corners, facilitating wiping of the dust-free cloth.

The two second support frames 242 fix the filter element 241 in the gas return passage 230 to prevent the filter element 241 from shaking. The filter element 241 is made of the polypropylene material, the sublimates generated after baking are organic, and the polypropylene easily adsorbs the sublimates. In addition, the polypropylene has relatively good corrosion resistance and heat resistance, and a melting point thereof is as high as 167° C. Because an internal temperature of the oven 200 is below 100° C., the polypropylene maintains a good physical property thereof during baking, and a filtering effect thereof is not affected. The filter element 241 consists of the filter screens 243. To improve a filtering effect of the filter element 241, the filter screens 243 are stacked into a plurality of layers, so that a distance at which the sublimates pass through the filter screens 243 is increased and the filtering effect of the filter element 241 is improved.

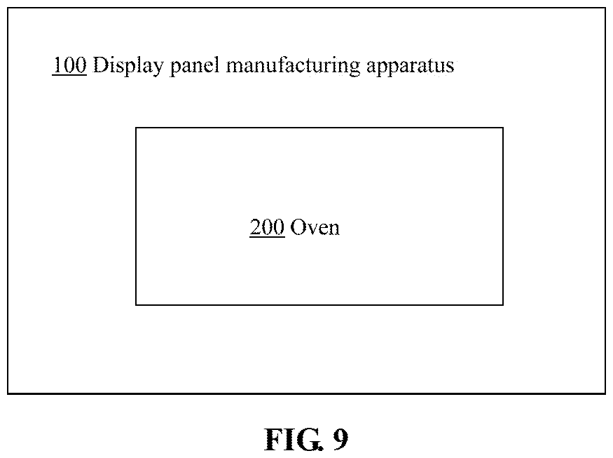

As shown in FIG. 9, another embodiment of the present application discloses a display panel manufacturing apparatus 100, including the oven 200 in the foregoing embodiments.

The technical solutions of the present application can be widely applied to a flat panel display such as a thin film transistor-liquid crystal display (TFT-LCD) and an organic light-emitting diode (OLED) display.

The foregoing is an optional detailed description of the present application with reference to specific optional embodiments, and it should not be considered that the specific implementation of the present application is not limited to the description. A person of ordinary skill in the art of the present application may further make several simple deductions or substitutions without departing from the concept of the present application, and the deductions or substitutions shall fall within the protection scope of the present application.

What is claimed is:

1. An oven, comprising:
an accommodation device, located inside the oven and configured to accommodate a color film substrate;
a suction device, configured to deliver gas into the oven;
a gas inlet passage, configured to convey hot gas into the accommodation device;
a gas return passage, configured to return the hot gas sent out from the accommodation device back to the gas inlet passage; and
a first filtering device, located inside the gas return passage.

2. The oven according to claim 1, wherein the suction device comprises a gas inlet, the gas inlet is located at a boundary between the gas inlet passage and the gas return passage, the gas inlet passage comprises a heating device, a gas supply device, and a second filtering device in sequence along a gas flow direction, the heating device is adjacent to the gas inlet, the gas supply device is adjacent to the heating device, and the second filtering device is disposed at a gas inlet position of the accommodation device.

3. The oven according to claim 1, wherein the accommodation device comprises first support frames and partition plates, the first support frames are stacked, accommodation space used to accommodate the color film substrate is formed between two adjacent first support frames, and the partition plates are disposed on the first support frames.

4. The oven according to claim 3, wherein a material of the partition plates is metal.

5. The oven according to claim 1, wherein the oven comprises a door plate, an exhaust passage, and an exhaust hole, the exhaust passage is located outside the gas return passage, the door plate is located outside an inner exhaust duct, and the exhaust hole is disposed on a side wall of the exhaust passage to discharge gas in the gas return passage out of the oven.

6. The oven according to claim 5, wherein the exhaust hole is circular in shape.

7. The oven according to claim 1, wherein the first filtering device comprises a filter element and second support frames, there are two second support frames, the second support frames are disposed in parallel, the filter element is disposed between the two second support frames, and the filter element is made of a polypropylene material.

8. The oven according to claim 7, wherein the filter element comprises at least two layers of filter screens, and the filter screens are stacked.

9. An oven, comprising:
an accommodation device, located inside the oven and configured to accommodate a color film substrate;
a suction device, configured to deliver gas into the oven;
a gas inlet passage, configured to convey hot gas into the accommodation device;
a gas return passage, configured to return the hot gas sent out from the accommodation device back to the gas inlet passage;
a first filtering device, located inside the gas return passage;
an exhaust passage, located outside the gas return passage;
a door plate, located outside the exhaust passage; and
an exhaust hole, disposed on a side wall of the exhaust passage to discharge gas in the gas return passage out of the oven, wherein
the accommodation device comprises first support frames and partition plates, the first support frames are stacked, and accommodation space used to accommodate the color film substrate is formed between two adjacent layers of the first support frames; the partition plates are disposed on the first support frames; the filtering device comprises a filter element and second support frames, there are two second support frames, the second support frames are disposed in parallel, the filter element is disposed between the two second support frames, and the filter element is made of a polypropylene material; and the filter element comprises at least two layers of filter screens, and the filter screens are stacked.

10. A display panel manufacturing apparatus, comprising an oven, wherein the oven comprises:
an accommodation device, located inside the oven and configured to accommodate a color film substrate;
a suction device, configured to deliver gas into the oven;
a gas inlet passage, configured to convey hot gas into the accommodation device;
a gas return passage, configured to return the hot gas sent out from the accommodation device back to the gas inlet passage; and
a first filtering device located in the gas return passage.

11. The display panel manufacturing apparatus according to claim 10, wherein the suction device comprises a gas inlet, the gas inlet is located at a boundary between the gas inlet passage and the gas return passage, the gas inlet passage comprises a heating device, a gas supply device, and a second filtering device in sequence along a gas flow direction, the heating device is adjacent to the gas inlet, the gas supply device is adjacent to the heating device, the second filtering device is arranged at a gas inlet position of the accommodation device.

12. The display panel manufacturing apparatus according to claim 10, wherein the accommodation device comprises first support frames and partition plates, the first support frames are stacked, accommodation space configured to accommodate the color film substrate is formed between two adjacent layers of the first support frames, and the partition plates are disposed on the first support frames.

13. The display panel manufacturing apparatus according to claim 12, wherein a material of the partition plates is metal.

14. The display panel manufacturing apparatus according to claim 10, wherein the oven comprises a door plate, an exhaust passage, and an exhaust hole, the exhaust passage is located outside the gas return passage, the door plate is located outside an inner exhaust duct, and the exhaust hole is disposed on a side wall of the exhaust passage to discharge gas in the gas return passage out of the oven.

15. The display panel manufacturing apparatus according to claim 14, wherein the exhaust hole is circular in shape.

16. The display panel manufacturing apparatus according to claim 10, wherein the first filtering device comprises a filter element and second support frames, there are two second support frames, the second support frames are disposed in parallel, the filter element is disposed between the two second support frames, and the filter element is made of a polypropylene material.

17. The display panel manufacturing apparatus according to claim 16, wherein the filter element comprises at least two layers of filter screens, and the filter screens are stacked.

18. The display panel manufacturing apparatus according to claim 10, wherein the first filtering device comprises a filter element and second support frames, there are two second support frames, the second support frames are disposed in parallel, and the filter element is disposed between the two second support frames, and the filter element is made of a polysulfone ultrafiltration membrane material.
